(19) United States
(12) Patent Application Publication
(10) Pub. No.: US 2024/0326522 A1
(43) Pub. Date: Oct. 3, 2024

(54) SYSTEM FOR INFLATING VEHICLE TIRES

(71) Applicant: Airdown, Inc., Beverly Hills, FL (US)

(72) Inventor: Alfred Robert Tomlinson, Beverly Hills, FL (US)

(73) Assignee: Airdown, Inc., Beverly Hills, FL (US)

(21) Appl. No.: 18/666,079

(22) Filed: May 16, 2024

Related U.S. Application Data
(63) Continuation-in-part of application No. 18/057,862, filed on Nov. 22, 2022.
Application No. 18/057,862 is a continuation of application No. 16/700,082, filed on Dec. 2, 2019, now Pat. No. 11,529,831.
Application No. 16/700,082 is a continuation of application No. 15/660,065, filed on Jul. 26, 2017, now Pat. No. 10,493,808.

(51) Int. Cl. B60C 23/00; B60C 29/06; B60S 5/04

(52) U.S. Cl. CPC B60C 23/00354; B60C 23/00363; B60C 29/066; B60C 29/068; B60C 2200/06; B60S 5/046

(57) ABSTRACT

A system for inflating vehicle tires including: (1) a valve positionable between an opened and a closed position; (2) a pneumatic pathway having a pressure value and in fluid communication with an outlet of the valve and an input of a pressure switch; (3) a vehicle tire in fluid communication with the pneumatic pathway; and (4) the pressure switch configured to actuate the valve to the opened position when the pressure value of the pneumatic pathway drops below a threshold value; and wherein an inlet of the valve is configured to be in fluid communication with an air tank having a pressure value.

### RELATED APPLICATIONS

This application is a continuation-in-part application of and claims priority under 35 U.S.C. § 120 of U.S. patent application Ser. No. 18/057,862 (Attorney Docket No. 4701.00003) filed on Nov. 22, 2022 and titled CENTRAL TIRE INFLATION SYSTEM, which in turn is a continuation application of and claims priority under 35 U.S.C. § 120 of U.S. patent application Ser. No. 16/700,082, now U.S. Pat. No. 11,529,831, issued Dec. 20, 2022 (Attorney Docket No. 4701.00002) filed on Dec. 2, 2019 and titled CENTRAL TIRE INFLATION SYSTEM, which in turn is a continuation application of and claims priority under 35 U.S.C. § 120 of U.S. patent application Ser. No. 15/660,065, now U.S. Pat. No. 10,493,808, issued Dec. 3, 2019 (Attorney Docket No. 4701.00004) filed on Jul. 26, 2017 and titled CENTRAL TIRE INFLATION SYSTEM. The contents of these applications are incorporated herein by reference.

### FIELD OF THE INVENTION

The present invention relates generally to tire inflation systems. More specifically, but not by way of limitation, the present invention relates to a central tire inflation system for vehicles to provide air to tires that have developed leaks while preventing an onboard air tank from being depleted.

### BACKGROUND OF THE INVENTION

Central tire inflation systems are commonly utilized on large commercial trucks to increase the performance of the truck across alternate terrain types. By way of example but not limitation, inflation systems are common on military vehicles that must traverse alternate terrains during a mission wherein the vehicle may be traversing across loose sand to asphalt in a single trip. It is desirable during traversing to ensure that tires remain adequately inflated even if the tire develops a leak.

One issue with existing tire inflation systems is the use of external shut off valves. Utilization of external shutoff valves prevents the ability for the central tire inflation system to maintain a minimum tire pressure in the event of a tire emergency. If a tire suffers a catastrophic failure on a conventional central tire inflation system the tire can completely lose all of its air pressure, which can cause the tire to dislodge from the wheel and cause more damage to the vehicle. A further issue with existing central tire inflation systems is their inability to adjust to various vehicle wheel sizes and bolt patterns. Existing systems are limited to the wheel sizes and are unable to adjust to accommodate alternate wheel sizes restricting the ability for the central tire inflation system to be moved between vehicles.

Accordingly, there is a need for a central tire inflation system that is configured to provide a supply of air to inhibit a tire from completing losing air pressure.

### SUMMARY OF THE INVENTION

With the above in mind, embodiments of the present invention are related to a system for inflating vehicle tires including a valve, a pneumatic pathway, a vehicle tire, and a pressure switch. The valve may be positionable between an opened and a closed position. The pneumatic pathway may have a pressure value and be in fluid communication with an outlet of the valve and an input of a pressure switch. The vehicle tire may be in fluid communication with the pneumatic pathway. The pressure switch may be configured to actuate the valve to the opened position when the pressure value of the pneumatic pathway drops below a threshold value. The valve may have an inlet configured to be in fluid communication with an air tank having a pressure value.

The pressure value of the air tank may be configured to be greater than the threshold value.

The threshold value may be selectable between 25 and 105 psi. In one embodiment, the threshold value may be selectable between 80 and 100 psi.

The system may further include a power switch, a first led, and a second led.

The first led may be configured to actuate when the power switch is in a closed configuration.

The second led may be configured to actuate when the pressure switch is activated.

The system may include the air tank, which may be in fluid communication with the inlet of the valve.

In one embodiment, the system may include an engine and an air compressor. The air compressor may be configured to receive power from the engine and having an outlet in fluid communication with the air tank.

In one embodiment, the system may include a first one-way check valve and a second one-way check valve.

The first one-way check valve may be positioned between an outlet of the air tank and the inlet of the valve. The first one-way check valve may be oriented to prevent the flow of air from the inlet of the valve into the air tank.

The second one-way check valve may be positioned between an outlet of the valve and the tire. The second one-way check valve may be oriented to prevent the flow of air from the tire into the pneumatic pathway.

The system may include an air passageway having a ninety-degree bend positioned between the air tank and the inlet of the valve.

### BRIEF DESCRIPTION OF THE DRAWINGS

Some embodiments of the present invention are illustrated as an example and are not limited by the figures of the accompanying drawings, in which like references may indicate similar elements.

FIG. 1 is an exploded view of the wheel assembly according to an embodiment of the present invention.

FIG. 2 is a top view of the wheel assembly of the present invention.

FIG. 3 is a detailed view of the controller of the present invention.

FIG. 4 is a diagrammatic view of the control panel and an exemplary screen display of the present invention.

FIG. 5 is a flow chart of an exemplary method of use of the present invention.

FIG. 6 is an exploded perspective view of the wheel assembly according to an embodiment of the present invention.

FIG. 7 is an exploded side view of the wheel assembly of FIG. 6.

FIG. 8 is a top plan view of the housing of the wheel assembly of FIG. 6.

FIG. 9 is a bottom plan view of the housing of FIG. 6.

FIG. 10 is a side view of the wheel assembly of FIG. 6.

FIG. 11 is a perspective view of the wheel assembly of FIG. 6.

FIG. 12 is a side elevation view of the wheel assembly of FIG. 6.

FIG. 13 is a block diagram of the pneumatic connections of the system for inflating vehicle tires according to an embodiment of the invention.

FIG. 14 is a block diagram of the electrical connections of the system for inflating vehicle tires according to an embodiment of the invention.

FIG. 15 is a front elevation view of the system for inflating vehicle tires according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

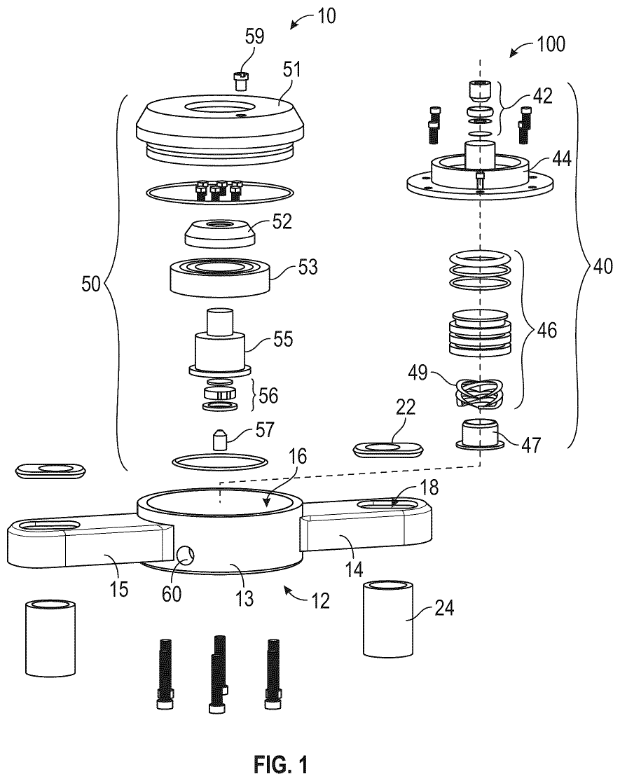

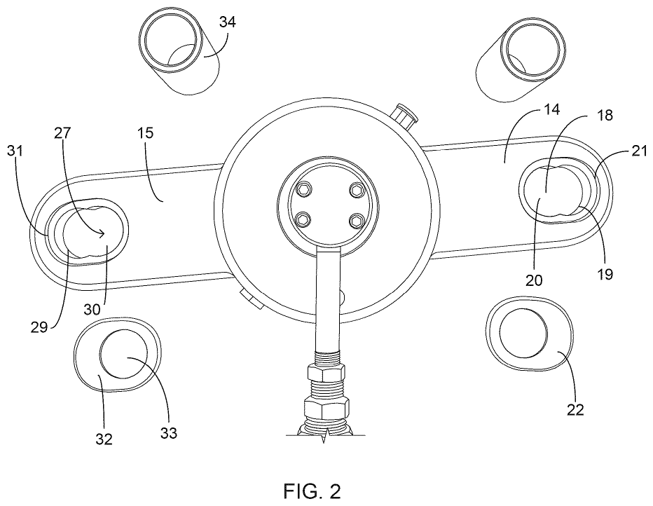

An embodiment of the invention, as shown and described by the various figures and accompanying text, provides a central tire inflation system 100, which includes a wheel assembly 10. Referring to FIGS. 1 and 2, the wheel assembly is provided to be mounted to each wheel of a vehicle in which the central tire inflation system 100 has been installed. The wheel assembly 10 includes a housing 12 wherein the housing 12 includes a central portion 13 and a first arm member 14 and second arm member 15. The housing 12 is manufactured from a suitable durable material such as but not limited to aluminum. The central portion 13 of the housing is annular in shape and includes cavity 16. Integrally formed with the central portion 13 of the housing 12 are first arm member 14 and second arm member 15. The first arm member 14 and second arm member 15 are formed on opposing sides of the central portion 13 of the housing 12. First arm member 14 and second arm member 15 function to span substantially across a vehicle wheel so as to be operably coupled thereto. It is contemplated within the scope of the present invention that the housing 12 could be manufactured in alternate sizes so as to accommodate vehicle wheels having different diameters. First arm member 14 further includes aperture 18 journaled therethrough distal to the central portion 13. The aperture 18 is a joined circle configuration having a first portion 19 and second portion 20 wherein the aperture 18 is generally oval in shape. The joined circle configuration of the aperture 18 provides a technique for the wheel assembly 10 to be operably coupled to various lug patterns of wheels of vehicles. The joined circle configuration permits lateral adjustment of a fastening lug to provide optimum positioning. The aperture 18 further includes ledge 21 wherein ledge 21 is circumferentially disposed around aperture 18. Ledge 21 functions to releasably secure adapter ring 22 therein. Ring adapter 22 further includes hole 23 suitable in size so as to accommodate a bolt therethrough. Operably coupled to aperture 18 is wheel mount 24. Wheel mount 24 is cylindrical in shape being hollow so as to accommodate a bolt therethrough. Second arm member 15 further includes aperture 27 journaled therethrough distal to the central portion 13. The aperture 27 is a joined circle configuration having a first portion 29 and second portion 30 wherein the aperture 27 is generally oval in shape. The aperture 27 further includes ledge 31 wherein ledge 31 is circumferentially disposed around aperture 27. Ledge 31 functions to releasably secure adapter ring 32 therein. Ring adapter 32 further includes hole 33 suitable in size so as to accommodate a bolt therethrough. Operably coupled to aperture 27 is wheel mount 34. Wheel mount 34 is cylindrical in shape being hollow so as to accommodate a bolt therethrough. Wheel mount 34 in combination with wheel mount 24 functions to provide a standoff mounting technique for housing 12. Further, the joined circle configurations of apertures 18,27 provide the ability to laterally position a fastener therein so as to accommodate alternate wheel diameters.

In one embodiment, disposed within cavity 16 of the central portion 13 are the check valve assembly 40 and the bearing/cap assembly 50. The check valve assembly 40 functions as a conventional check valve allowing air flow into the wheel assembly 10 and is configured to maintain a minimum tire pressure to a tire on a wheel to which the wheel assembly 10 is mounted. The check valve assembly 40 includes upper seal/spring group 42. A seat cup assembly 44 is further included. The lower seal/spring group 46 is operably coupled to seat cup 44 and is secured utilizing hat washer 47. As will be further discussed herein, the check valve assembly 40 provides an adjustable technique to maintain a minimum air pressure for all tires to which the wheel assembly 10 is fluidly coupled. Spring 49 is configured to have adjustable tension so as to allow a user of the central tire inflation system 100 to set a minimum air pressure for the tires operably coupled thereto. By way of example but not limitation, it is contemplated within the scope of the present invention that the spring 49 has a tension so as to inhibit a pressure lower than 20 PSI within the tires.

The bearing/cap assembly 50 is operably disposed within the cavity 16 of the central portion 13. The bearing/cap assembly 50 includes the following elements: cover 51, cap 52, roller bearing 53, tube 55, retaining ring assembly 55 and adjustment screw 57. A grease fitting 59 is operably coupled to cover 51 and provides an operable coupling technique to inject the necessary lubricant into the cavity 16 of the central portion 13. The aforementioned elements of the bearing/cap assembly 50 provide rotatable coupling of the check valve assembly 40 within the cavity 16 of the central portion 13. It is contemplated within the scope of the present invention that alternate configurations of the bearing/cap assembly 50 could be provided with alternate elements and still achieve the desired functionality discussed herein. Central portion 13 includes aperture 60 that is a port for air to be fluidly directed to a tire to which the wheel assembly 10 is mounted.

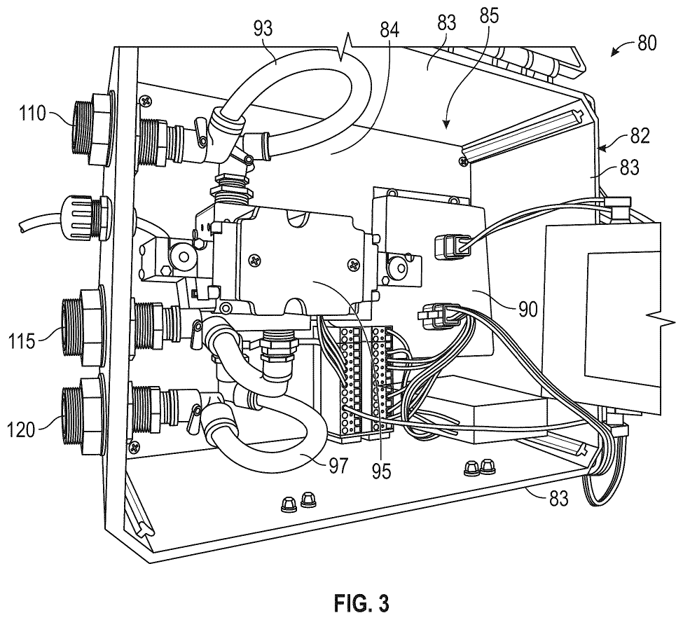

Illustrated in particular in FIG. 3 herein is the controller 80. The controller 80 is operably coupled to the wheel assembly 10 and includes the necessary electronic and pneumatic components to facilitate the operation of the central tire inflation system 100. Controller 80 includes housing 82 that is formed from a rigid material such as but not limited to metal or plastic and is generally rectangular in shape having integrally formed walls 83 and a bottom 84 forming an interior volume 85. It should be noted that in FIG. 3 herein that a top for the controller 80 is not illustrated so as to show the internal components thereof. Disposed within the interior volume 85 of the housing 82 is central processing unit 90. The central processing unit 90 includes the necessary electronic components to store, receive, transmit and manipulate data to provide operation of the central tire inflation system 100. The central processing unit 90 is operable coupled to valve 95 and provides control thereof. Valve 95 is a conventional pneumatic valve that is pneumatically coupled to the wheel assembly 10 via the first port 110. The valve 95 is pneumatically coupled to a first port 110, a second port 115 and a third port 120. The valve 95 under operable control of the central processing unit 90 will direct airflow as required to achieve an input air pressure for tires operably coupled to the wheel assembly 10. The first port 110 is fluidly coupled to valve 95 utilizing tube 93. First port 110 is fluidly coupled to the wheel assembly 10 utilizing conventional hosing (not illustrated herein). In the event that a tire operably coupled to a wheel assembly 10 has a air pressure lower than that required, the valve 95 will move to a position such that the valve 95 will direct air flow into tube 93 and discharge from the first port 110 so as to be transported to the tire(s) so as to achieve the desired minimum air pressure. Third port 120 is operably coupled to a conventional air source such as but not limited to an air tank or an air compressor (not particularly illustrated herein). When an increase in air pressure for a tire(s) operably coupled to a wheel assembly 10 is required, the valve 95 is positioned so as to receive air from the third port 120 and discharge air from the first port 110. The third port 120 is fluidly coupled to the valve 95 utilizing tube 97. In the inflate mode of the central tire inflation system 100 the valve 95 will intake air from an air source via third port 120 and discharge air via the first port 110 which is directed to the tires having the wheel assembly 10 operably coupled thereto. The valve 95 further includes an integrated pressure sensor (not illustrated herein) that monitors the air pressure within the central tire inflation system 100 and will provide either inflation or deflation of the tires operably coupled to the wheel assembly 10 as needed.

In the deflate mode, the controller 90 will provide deflation of the tires operably coupled to the wheel assembly 10. As will be further discussed herein, the central tire inflation system 100 provides a user the ability to both inflate and deflate the tires programmatically through a control panel 150. In the deflate mode, the valve 95 is positioned so as to permit airflow inward from the first port 110 and is discharged through the second port 115. The second port 115 is a discharge port that is atmospherically coupled to the external environment wherein the air received from the first port 110 in the deflate mode is discharged into the environment via the second port 115.

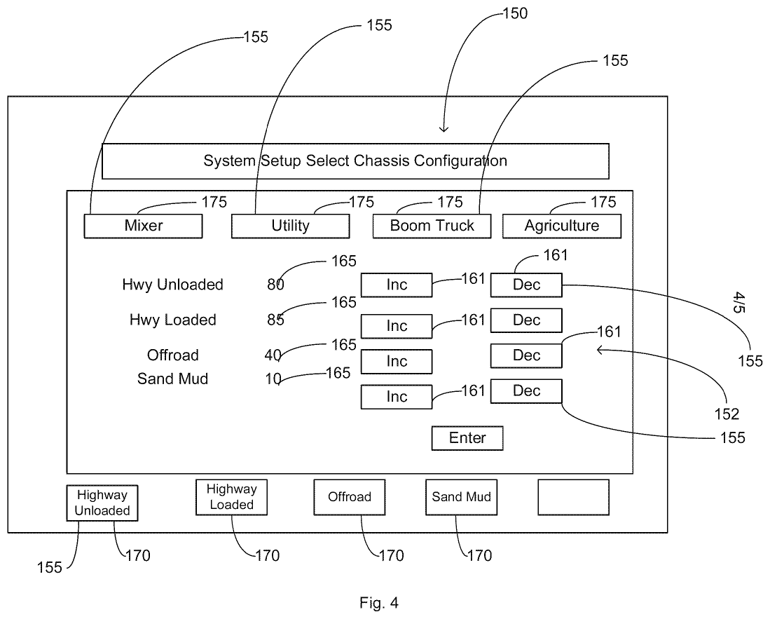

Referring to FIG. 4 herein, a diagrammatic view of the control panel 150 is illustrated therein. The control panel 150 includes a graphical display 152 having a plurality of icons 155 and functions to provide the user interface for a user to operate the central tire inflation system 100. The graphical display 152 is a conventional touch screen interface and the control panel 150 is operably coupled to controller 80. Icons 175 are vehicle type icons. The central tire inflation system 100 is designed to be installed on various vehicle types that are utilized in alternate industries so as to execute a desired task. By way of example but not limitation, the central tire inflation system 100 can be mounted to a concrete mixer truck or a power utility truck. Both of the aforementioned vehicle types operate in different conditions and traverse across various terrains during execution of the intended functionality for that vehicle type. As such, the required tire pressure for the tires on the aforementioned vehicles must not only maintain a minimum air pressure but it is further desired that the operator of the vehicle be able to alter the air pressure within the tires depending upon the type of surface the vehicle is being driven on and what type of load the vehicle may be subjected to during operation. The vehicle type icons 175 provide the user of the central tire inflation system 100 to set desired tire air pressure through engagement of just the vehicle type icon and the default parameters stored in the central processing unit 90 for the vehicle type activated and initiated. While the graphical display 152 control panel 150 has illustrated herein four vehicle type icons 175 and further has exemplary vehicle types listed thereon, it is contemplated within the scope of the present invention that the control panel 150 could have more or less than four vehicle type icons 175 and could further have alternate vehicle types and parameters therefore programmed into the central processing unit 90.

The graphical display 152 further has displayed thereon adjustment icons 161. The adjustment icons 161 have indicia therein indicating increase or decrease more specifically abbreviations, Inc and Dec. The adjustment icons 161 provide a technique to a user to adjust the default tire air pressure for the current mode displayed on the graphical display 152. In the exemplary parameters illustrated in FIG. 4 herein, the recommended highway unloaded tire air pressure that is desires, set and monitored is 80 PSI. If a user desires to alter the default setting of 80 PSI, the user will engage the adjustment icons 161 so as to increase and/or decrease the default PSI setting. Ensuing the adjustment of the default air pressure, the central processing unit 90 stores the adjusted values for the default air pressure. It is contemplated within the scope of the present invention that the tire air pressure parameter settings 165 can be adjusted and stored in the central processing unit 90. It is further contemplated within the scope of the present invention that the central tire inflation system 100 could require a password in order to permit a user to execute the aforementioned adjustments to default air pressure. It should be understood that FIG. 4 depicts a system setup screen display for the central tire inflation system 100. It is further contemplated within the scope of the present invention that numerous alternate screens will be displayed on the graphical display 152 of the control panel 150. These alternate screens are further discussed herein and include but are not limited to a warning screen, a fault log screen, a diagnostic screen and a manual control screen. Still referring to FIG. 4, the graphical display 152 of the control panel 150 further includes mode selection icons 170. The mode selection icons 170 provide a user an interface to identify and select the driving mode in which the vehicle that the central tire inflation system 100 is operably coupled. Each alternate mode has associated therewith tire air pressure parameters and subsequent selection and activation of the mode, the central processing unit 90 will initiate the central tire inflation system 100 to inflate and/or deflate the tire air pressure according to the parameters associated with the selected mode. By way of example but not limitation, it is contemplated that the central tire inflation system 100 provides operational modes such as highway loaded, highway unloaded, off---road or sand---mud mode. These aforementioned operational modes have associated therewith pre---programmed tire air pressure parameters designed for the operational mode so as to provide the correct tire air pressure for the application of use. Furthermore, ensuing selection of the mode and activation thereof, the central processing unit 90 will continuously monitor the tire air pressure and make adjustments thereto in order to maintain the parameter settings for the selected mode. Additionally, each deviation from the tire air pressure parameters associated with active selected mode is recorded and stored in a fault log database within the central processing unit 90 for subsequent access thereto.

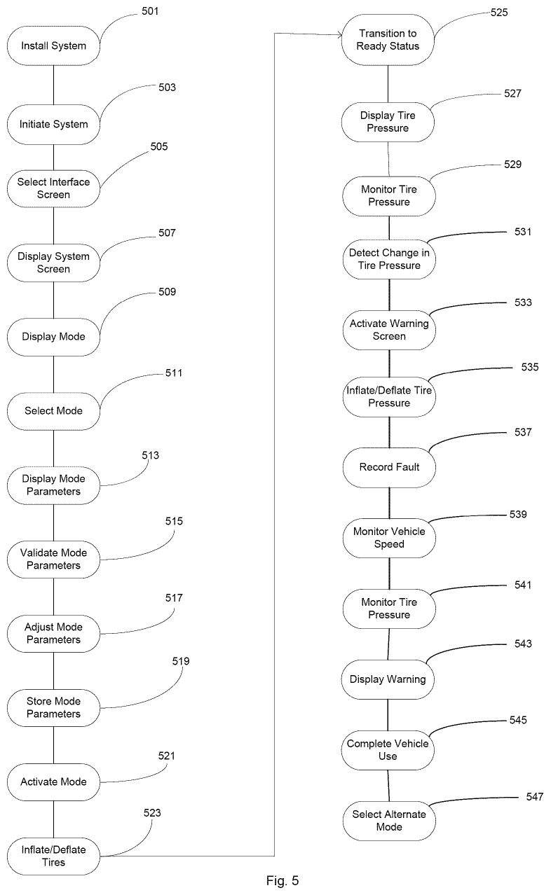

Referring now to FIG. 5 herein, a method of operation of the central tire inflation system 100 is as follows. In step 501, the central tire inflation system 100 is installed on a vehicle such as but not limited to a commercial truck. Installation of the central tire inflation system 100 includes but is not limited to tasks such as mounting the wheel assembly 10 to the tires of the commercial truck and placing the controller 80 and control panel in the passenger compartment thereof. In step 503, the central tire inflation system 100 is initiated wherein the central processing unit 90 is activated and the control panel 150 is utilized to commence system operation. Step 505, the user will be provided an interface screen to continue operation of the central tire inflation system 100, wherein the interface screen is at least one of the following: a diagnostic screen, a warning screen, a fault log screen, a manual control screen and a system set up screen. In step 507, a user will select the system set up screen, which has been illustrated herein in FIG. 5. Step 509, the control panel 150 will display both vehicle type icons 175 and mode selection icons 170. In step 511, a user will select a vehicle type and a mode of use as previously discussed herein. Step 513, the control panel 150 will display the mode parameters on the graphical display 152. In step 515, the user will be prompted to validate the mode parameters that have been displayed on the graphical display 152. Step 517, the user may either validate the mode parameters or adjust the mode parameters utilizing the adjustment icons 161. It should be understood within the scope of the present invention that only an authorized user with a password can make adjustments to the mode parameters utilizing the adjustment icons 161. In step 519, if the mode parameters were adjusted utilizing the adjustment icons 161, the central processing unit 190 records and stores the adjusted mode parameters.

Step 521, the user will activate the selected mode and the central tire inflation system 100 will initiate operation. In step 523, the central tire inflation system 100 will detect an initial tire air pressure and will either inflate or deflate the tires as necessary so as to align with the mode parameters activated. Step 525, the central tire inflation system 100 will transition to an initial ready status wherein the tires have been adjusted to the air pressure as defined in the selected mode. In step 527, the central tire inflation system 100 will display the current tire pressure on the graphical display 152. Step 529, the central tire inflation system 100 will continuously monitor the tire air pressure on which the central tire inflation system 100 is installed. In step 531, the valve 95 having the integrated pressure sensor detects a pressure in a tire that has deviated from the tire air pressure parameter in the active mode. Step 533, the central processing unit 90 transmits a signal to the control panel 150 to display a warning signal on the graphical display that a tire has an air pressure that has deviated from the stored parameters for the active mode. In step 535, the central processing unit 90 transmits a signal to the valve 95 to initiate either inflation or deflation of the tires so as to return the tire air pressure to the tire pressure parameter of the active mode. Step 537, the central processing unit 90 records the deviation and stores in the memory thereof particularly in a fault log database for future access by a user. In step 539, the central tire inflation system 100 continues to monitor the tire air pressure of the vehicle and further monitors the speed of the vehicle. It is contemplated within the scope of the present invention that the central tire inflation system 100 could be operably integrated into the speedometer of the vehicle so as to extract the vehicle speed and display on the graphical display 152 of the control panel 150. Those skilled in the art should recognize that the vehicle speed could be obtained utilizing alternate devices and/or techniques. In step 541, the central tire inflation system 100 continues to monitor the tire pressure and compare to the tire pressure parameters of the active mode. Step 543, the central tire inflation system 100 will display a warning if the vehicle speed exceeds the recommended speed for the active mode. The warning signal is generated by the central processing unit 90 and is transmitted to the control panel 150 for display to the user. In step 545, the user completes the vehicle use. In step 547, a second user will select a mode in which the user will begin to utilize the vehicle to which the central tire inflation system 100 is mounted. The aforementioned second user could be the same individual initiating re---use of the vehicle. Operation of the central tire inflation system 100 returns to step 513 and resume all of the aforementioned steps of operation through step 513 to step 545.

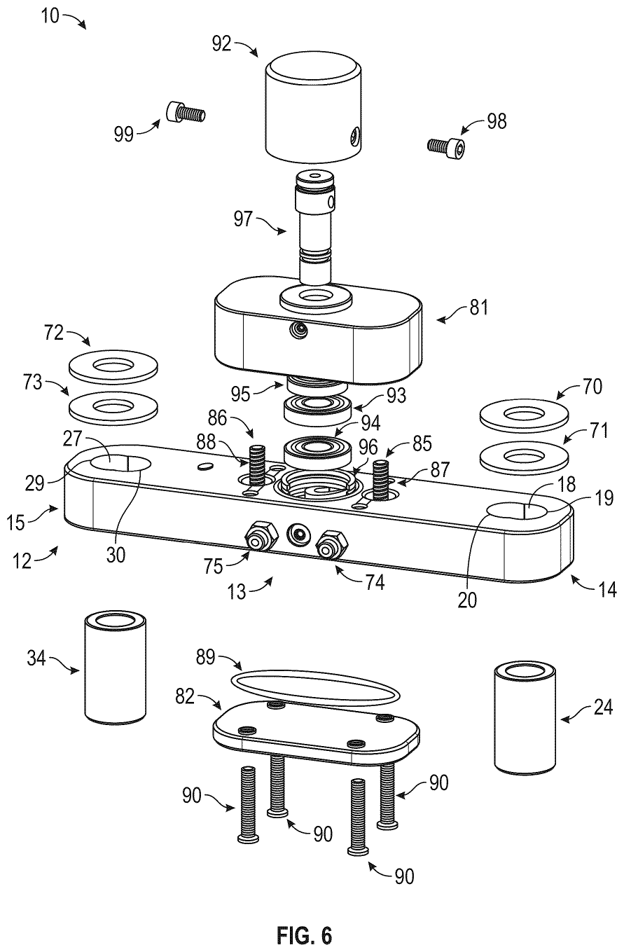

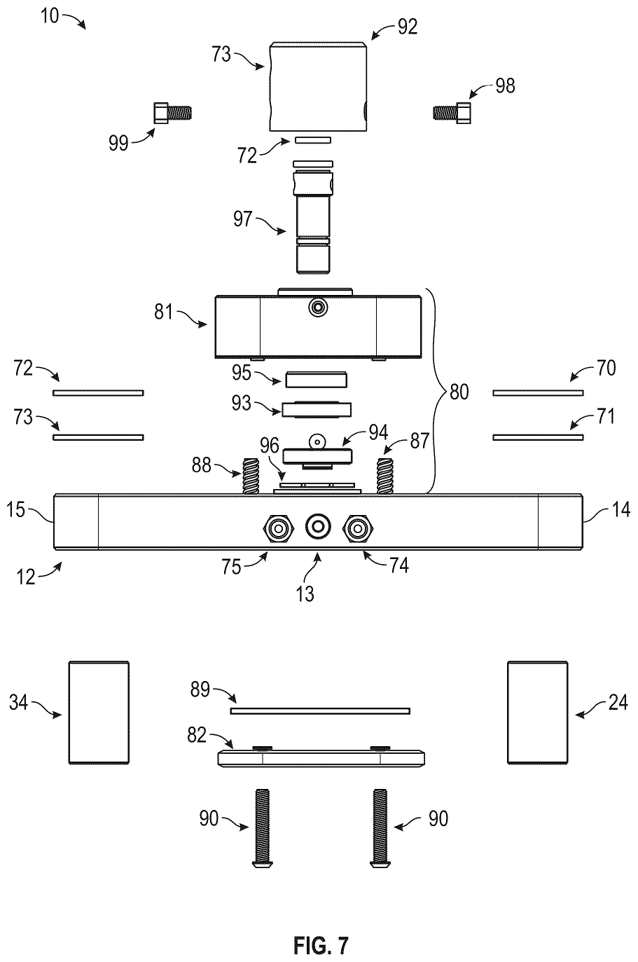

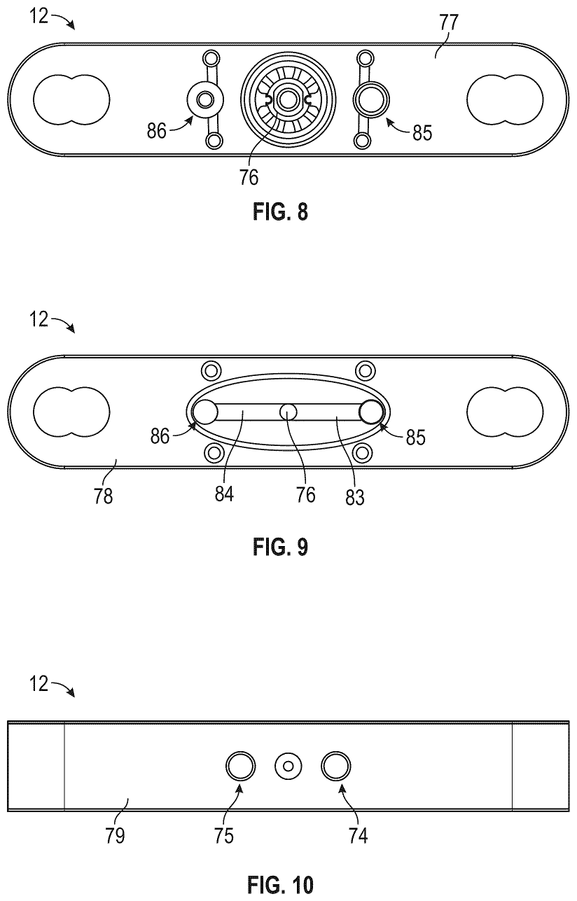

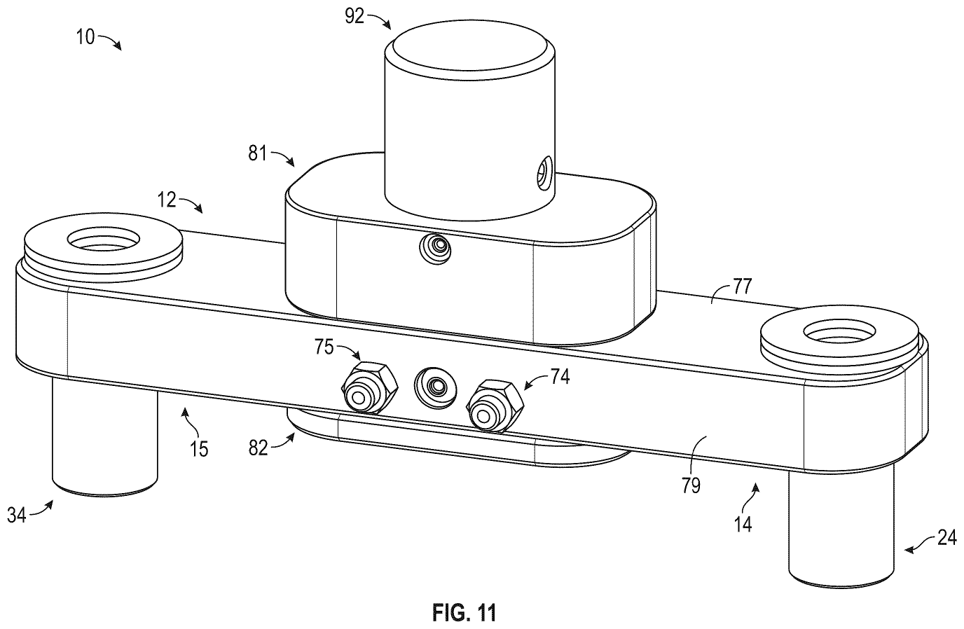

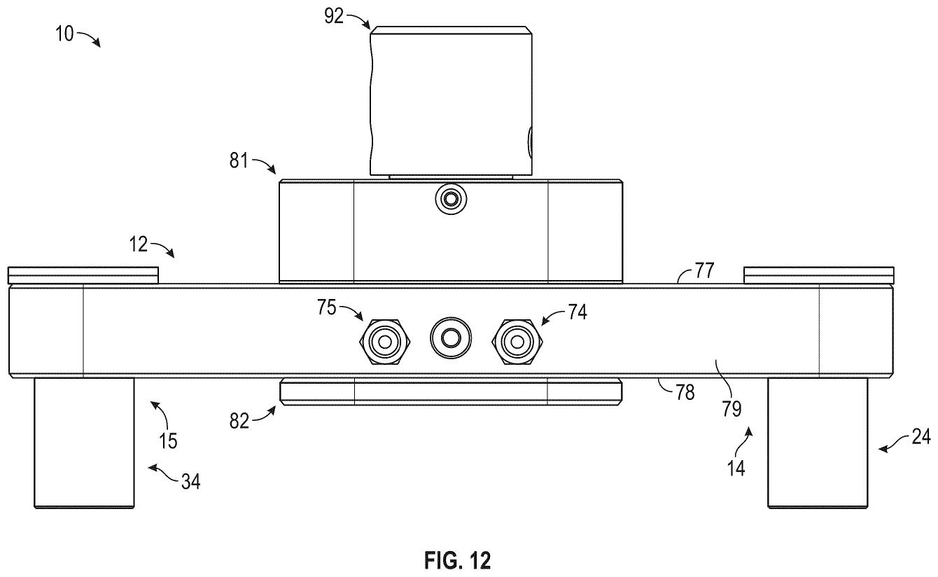

Referring now to FIG. 6, another embodiment of the wheel assembly 10 is provided to be mounted to at least one wheel of a vehicle in which the central tire inflation system 100 has been installed. In such an embodiment, the wheel includes two tires and the wheel assembly 10 is configured to independently control the pressure level in each of the two tires. The wheel assembly 10 includes a housing 12 wherein the housing 12 includes a central portion 13 and a first arm member 14 and second arm member 15. The housing 12 is manufactured from a suitable durable material such as but not limited to aluminum. The central portion 13 of the housing includes a cavity. Integrally formed with the central portion 13 of the housing 12 are first arm member 14 and second arm member 15. The first arm member 14 and second arm member 15 are formed on opposing sides of the central portion 13 of the housing 12. First arm member 14 and second arm member 15 function to span substantially across a vehicle wheel so as to be operably coupled thereto. It is contemplated within the scope of the present invention that the housing 12 could be manufactured in alternate sizes so as to accommodate vehicle wheels having different diameters.

First arm member 14 further includes aperture 18 journaled therethrough distal to the central portion 13. The aperture 18 is a joined circle configuration having a first portion 19 and second portion 20 wherein the aperture 18 is generally oval in shape. The joined circle configuration of the aperture 18 provides a technique for the wheel assembly 10 to be operably coupled to various lug patterns of wheels of vehicles. The joined circle configuration permits lateral adjustment of a fastening lug to provide optimum positioning. The aperture 18 may further include a ledge, as depicted in FIG. 1, wherein the ledge is circumferentially disposed around aperture 18. The ledge may function to releasably secure an adapter ring therein. One or more O-rings may be positioned above aperture 18. As depicted in FIG. 6, there are two O-rings 70, 71 positioned above aperture 18. The O-rings 70, 71 each include a central aperture suitable in size so as to accommodate a bolt therethrough. The bolt may be utilized to operably couple aperture 18 to wheel mount 24. Wheel mount 24 is cylindrical in shape and hollow so as to accommodate a bolt therethrough.

Second arm member 15 further includes aperture 27 journaled therethrough distal to the central portion 13. The aperture 27 is a joined circle configuration having a first portion 29 and second portion 30 wherein the aperture 27 is generally oval in shape. The aperture 27 may further includes a ledge, as depicted in FIG. 1, wherein the ledge is circumferentially disposed around aperture 27. The ledge may function to releasably secure an adapter ring therein. One or more O-rings may be positioned above aperture 27. As depicted in FIG. 6, there are two O-rings 72, 73 positioned above aperture 27. The O-rings 72, 73 each include a central aperture suitable in size so as to accommodate a bolt therethrough. The bolt may be utilized to operably couple aperture 27 to wheel mount 34. Wheel mount 34 is cylindrical in shape and hollow so as to accommodate a bolt therethrough. Wheel mount 34 in combination with wheel mount 24 function to provide a standoff mounting technique for housing 12. Further, the joined circle configurations of apertures 18, 27 provide the ability to laterally position a fastener therein so as to accommodate alternate wheel diameters.

A first check valve 85 is located in the housing 12 to the right of the bearing/cap assembly 80 and a second check valve 86 is located in the housing 12 to the left of the bearing/cap assembly 80. Each check valve 85, 86 functions as a conventional check valve and each, independently allows air to flow into one tire of the wheel assembly 10. The check valves 85, 86 are configured to maintain a minimum tire pressure to a tire on a wheel to which the wheel assembly 10 is mounted. The dual check valves 85, 86 provide an adjustable technique to maintain a minimum air pressure for each tire to which the wheel assembly 10 is fluidly coupled. Springs 87, 88 may be configured to have adjustable tension or may be selected to have a desired tension, allowing a user of the central tire inflation system 100 to set a minimum air pressure for the tires operably coupled thereto. The tension of the first spring 87 may be selected to close the first check valve 85 when the air pressure in the tire in fluid communication with the first check valve 85 falls below a first threshold. The tension of the second spring 88 may be selected to close the second check valve 86 when the air pressure in the tire in fluid communication with the second check valve 86 falls below a second threshold. The first and second thresholds may have the same or different values. By way of example but not limitation, it is contemplated within the scope of the present invention that each spring 87, 88 has a tension so as to inhibit a pressure lower than 20-15 psi within the tires. In one embodiment both the first and second thresholds may be 20 psi. In another embodiment, both the first and second thresholds may be 15 psi.

The bearing assembly 80 is positioned above the housing 12 and includes a bearing housing 81, a first roller bearing 93, a second roller bearing 94, a seal 95, and a washer 96. The first roller bearing 93, second roller bearing 94, seal 95, and washer 96 may be carried within the bearing housing 81 and extend into the cavity of the housing 12. A cap 92 may be located above the hearing housing 81. A shaft 97 may be fixedly secured to the cap 92 by a pair of set screws 98, 99, extend through the bearing housing 81 and be fixedly secured thereto. An O-ring 72 may be positioned between the top end of the shaft 97 and the inside of the cap 92. A central channel of the shaft 97 may provide fluid communication between an air inlet 73 located on the cap 92 and the cavity of the housing 12. The bearing assembly 50 provides rotatable coupling of the housing 12 to the cap 92. It is contemplated within the scope of the present invention that alternate configurations of the bearing assembly 50 could be provided with alternate elements and still achieve the desired functionality discussed herein. The shaft 97 may have a first end proximate the cap 92 and a second end positioned proximate the seal 95, forming an air tight seal therewith. The surface of the second end of the shaft 97 forms the seal with the seal 95 and therefore must be machined extremely flat to prevent leaks from occurring in this seal.

An air inlet 73 located through an entirety of a wall of the cap 92 may provide access to place a channel extending longitudinally along the length of the shaft 97 in fluid communication with an external pressurized air source. The pressurized air may be provided to the air inlet 73 and fill the channel located in the shaft 97. A central aperture may be formed in the seal 95, first roller bearing 93, and second roller bearing 94 to allow the pressurized air to pass through and enter the cavity of the housing 12.

The pressurized air may be present on a first side of the first check valve 85 and the first spring 87 may be configured to open the first check valve 85 to allow the pressurized air to pass to the second side of the first check valve 85 and out to the first tire air connector 74. The first tire air connector 74 is configured to be operably coupled to a first tire of a vehicle. When the pressure within the first tire is below a first threshold, the first spring 87 may operate to close the first check valve 85 and prevent air from traveling between the first side and second side of the first check valve 85. Such a configuration may prevent the first tire from losing air pressure when the external air source losses pressure. It may also prevent a blown tire from leaking air pressure from the external air system by closing the vale and preventing further air loss.

Similarly, he pressurized air may be present on a first side of the second check valve 86 and the second spring 88 may be configured to open the second check valve 86 to allow the pressurized air to pass to the second side of the second check valve 86 and out to the second tire air connector 75. The second tire air connector 75 is configured to be operably coupled to a second tire of a vehicle. When the pressure within the second tire is below a second threshold, the second spring 88 may operate to close the second check valve 86 and prevent air from traveling between the first side and second side of the second check valve 86. Such a configuration may prevent the second tire from losing air pressure when the external air source losses pressure. It may also prevent a blown tire from leaking air pressure from the external air system by closing the vale and preventing further air loss. When either the first check valve 85 or second check valve 86 is in the closed position, the first tire and second tire are not in fluid communication with one another. When both the first check valve 85 and the second check valve 86 are in the open position, the first tire, second tire, and external air supply are in fluid communication with each other.

The housing 12 may include passageways to allow the pressurized air to operate as described above. Turning to FIG. 9, the housing 12 may include a central channel 76 located through an entirety of the thickness of the housing 12 from the top side 77 to the bottom side 78 of the housing 12. This central channel 76 may be in fluid communication with the channel located along the length of the shaft 97. Air may pass from the channel of the shaft 97 through the central channel 76 and enter a first passageway 83 or a second passageway 84 formed on the bottom side 78 of the housing. The first passageway 83 may fluidly couple the first side of the first check valve 85 to the central channel 76. The second passageway 84 may fluidly couple the first side of the second check valve 86 to the central channel 76. A plate 82 may be secured to the bottom side 78 of the housing 12 to fully enclose the first passageway 83 and second passageway 84. An O-ring 89 may be fitted in a channel formed near a perimeter of the plate 82 and utilized to create an airtight seal between the plate 82 and the bottom side 79 of the housing 12. A plurality of bolts 90 may be utilized to secure the plate 82 to the housing 12.

When the first check valve 85 is open, the first passageway 83 may be in fluid communication with the first tire air connector 74 formed on a front side of the housing 12. When the first check valve 85 is closed, the first passageway 83 may be sealed off and not in fluid communication with the first tire air connector 74. When the second check valve 86 is open, the second passageway 84 may be in fluid communication with the second tire air connector 75 formed on a front side of the housing 12. When the second check valve 86 is closed, the second passageway 84 may be sealed off and not in fluid communication with the second tire air connector 75.

Illustrated in particular in FIG. 3 herein is the controller 80. The controller 80 is operably coupled to the wheel assembly 10 and includes the necessary electronic and pneumatic components to facilitate the operation of the central tire inflation system 100. Controller 80 includes housing 82 that is formed from a rigid material such as but not limited to metal or plastic and is generally rectangular in shape having integrally formed walls 83 and a bottom 84 forming an interior volume 85. It should be noted that in FIG. 3 herein that a top for the controller 80 is not illustrated so as to show the internal components thereof. Disposed within the interior volume 85 of the housing 82 is central processing unit 90. The central processing unit 90 includes the necessary electronic components to store, receive, transmit and manipulate data to provide operation of the central tire inflation system 100. The central processing unit 90 is operable coupled to valve 95 and provides control thereof. Valve 95 is a conventional pneumatic valve that is pneumatically coupled to the wheel assembly 10 via the first port 110. The valve 95 is pneumatically coupled to a first port 110, a second port 115 and a third port 120. The valve 95 under operable control of the central processing unit 90 will direct airflow as required to achieve an input air pressure for tires operably coupled to the wheel assembly 10. The first port 110 is fluidly coupled to valve 95 utilizing tube 93. First port 110 is fluidly coupled to the wheel assembly 10 utilizing conventional hosing (not illustrated herein). In the event that a tire operably coupled to a wheel assembly 10 has a air pressure lower than that required, the valve 95 will move to a position such that the valve 95 will direct air flow into tube 93 and discharge from the first port 110 so as to be transported to the tire(s) so as to achieve the desired minimum air pressure. Third port 120 is operably coupled to a conventional air source such as but not limited to an air tank or an air compressor (not particularly illustrated herein). When an increase in air pressure for a tire(s) operably coupled to a wheel assembly 10 is required, the valve 95 is positioned so as to receive air from the third port 120 and discharge air from the first port 110. The third port 120 is fluidly coupled to the valve 95 utilizing tube 97. In the inflate mode of the central tire inflation system 100 the valve 95 will intake air from an air source via third port 120 and discharge air via the first port 110 which is directed to the tires having the wheel assembly 10 operably coupled thereto. The valve 95 further includes an integrated pressure sensor (not illustrated herein) that monitors the air pressure within the central tire inflation system 100 and will provide either inflation or deflation of the tires operably coupled to the wheel assembly 10 as needed.

In the deflate mode, the controller 90 will provide deflation of the tires operably coupled to the wheel assembly 10. As will be further discussed herein, the central tire inflation system 100 provides a user the ability to both inflate and deflate the tires programmatically through a control panel 150. In the deflate mode, the valve 95 is positioned so as to permit airflow inward from the first port 110 and is discharged through the second port 115. The second port 115 is a discharge port that is atmospherically coupled to the external environment wherein the air received from the first port 110 in the deflate mode is discharged into the environment via the second port 115.

Referring to FIG. 4 herein, a diagrammatic view of the control panel 150 is illustrated therein. The control panel 150 includes a graphical display 152 having a plurality of icons 155 and functions to provide the user interface for a user to operate the central tire inflation system 100. The graphical display 152 is a conventional touch screen interface and the control panel 150 is operably coupled to controller 80. Icons 175 are vehicle type icons. The central tire inflation system 100 is designed to be installed on various vehicle types that are utilized in alternate industries so as to execute a desired task. By way of example but not limitation, the central tire inflation system 100 can be mounted to a concrete mixer truck or a power utility truck. Both of the aforementioned vehicle types operate in different conditions and traverse across various terrains during execution of the intended functionality for that vehicle type. As such, the required tire pressure for the tires on the aforementioned vehicles must not only maintain a minimum air pressure but it is further desired that the operator of the vehicle be able to alter the air pressure within the tires depending upon the type of surface the vehicle is being driven on and what type of load the vehicle may be subjected to during operation. The vehicle type icons 175 provide the user of the central tire inflation system 100 to set desired tire air pressure through engagement of just the vehicle type icon and the default parameters stored in the central processing unit 90 for the vehicle type activated and initiated. While the graphical display 152 control panel 150 has illustrated herein four vehicle type icons 175 and further has exemplary vehicle types listed thereon, it is contemplated within the scope of the present invention that the control panel 150 could have more or less than four vehicle type icons 175 and could further have alternate vehicle types and parameters therefore programmed into the central processing unit 90.

The graphical display 152 further has displayed thereon adjustment icons 161. The adjustment icons 161 have indicia therein indicating increase or decrease more specifically abbreviations, Inc and Dec. The adjustment icons 161 provide a technique to a user to adjust the default tire air pressure for the current mode displayed on the graphical display 152. In the exemplary parameters illustrated in FIG. 4 herein, the recommended highway unloaded tire air pressure that is desires, set and monitored is 80 PSI. If a user desires to alter the default setting of 80 PSI, the user will engage the adjustment icons 161 so as to increase and/or decrease the default PSI setting. Ensuing the adjustment of the default air pressure, the central processing unit 90 stores the adjusted values for the default air pressure. It is contemplated within the scope of the present invention that the tire air pressure parameter settings 165 can be adjusted and stored in the central processing unit 90. It is further contemplated within the scope of the present invention that the central tire inflation system 100 could require a password in order to permit a user to execute the aforementioned adjustments to default air pressure. It should be understood that FIG. 4 depicts a system setup screen display for the central tire inflation system 100. It is further contemplated within the scope of the present invention that numerous alternate screens will be displayed on the graphical display 152 of the control panel 150. These alternate screens are further discussed herein and include but are not limited to a warning screen, a fault log screen, a diagnostic screen and a manual control screen. Still referring to FIG. 4, the graphical display 152 of the control panel 150 further includes mode selection icons 170. The mode selection icons 170 provide a user an interface to identify and select the driving mode in which the vehicle that the central tire inflation system 100 is operably coupled. Each alternate mode has associated therewith tire air pressure parameters and subsequent selection and activation of the mode, the central processing unit 90 will initiate the central tire inflation system 100 to inflate and/or deflate the tire air pressure according to the parameters associated with the selected mode. By way of example but not limitation, it is contemplated that the central tire inflation system 100 provides operational modes such as highway loaded, highway unloaded, off---road or sand---mud mode. These aforementioned operational modes have associated therewith pre---programmed tire air pressure parameters designed for the operational mode so as to provide the correct tire air pressure for the application of use. Furthermore, ensuing selection of the mode and activation thereof, the central processing unit 90 will continuously monitor the tire air pressure and make adjustments thereto in order to maintain the parameter settings for the selected mode. Additionally, each deviation from the tire air pressure parameters associated with active selected mode is recorded and stored in a fault log database within the central processing unit 90 for subsequent access thereto.

Referring now to FIG. 5 herein, a method of operation of the central tire inflation system 100 is as follows. In step 501, the central tire inflation system 100 is installed on a vehicle such as but not limited to a commercial truck. Installation of the central tire inflation system 100 includes but is not limited to tasks such as mounting the wheel assembly 10 to the tires of the commercial truck and placing the controller 80 and control panel in the passenger compartment thereof. In step 503, the central tire inflation system 100 is initiated wherein the central processing unit 90 is activated and the control panel 150 is utilized to commence system operation. Step 505, the user will be provided an interface screen to continue operation of the central tire inflation system 100, wherein the interface screen is at least one of the following: a diagnostic screen, a warning screen, a fault log screen, a manual control screen and a system set up screen. In step 507, a user will select the system set up screen, which has been illustrated herein in FIG. 5. Step 509, the control panel 150 will display both vehicle type icons 175 and mode selection icons 170. In step 511, a user will select a vehicle type and a mode of use as previously discussed herein. Step 513, the control panel 150 will display the mode parameters on the graphical display 152. In step 515, the user will be prompted to validate the mode parameters that have been displayed on the graphical display 152. Step 517, the user may either validate the mode parameters or adjust the mode parameters utilizing the adjustment icons 161. It should be understood within the scope of the present invention that only an authorized user with a password can make adjustments to the mode parameters utilizing the adjustment icons 161. In step 519, if the mode parameters were adjusted utilizing the adjustment icons 161, the central processing unit 190 records and stores the adjusted mode parameters.

Step 521, the user will activate the selected mode and the central tire inflation system 100 will initiate operation. In step 523, the central tire inflation system 100 will detect an initial tire air pressure and will either inflate or deflate the tires as necessary so as to align with the mode parameters activated. Step 525, the central tire inflation system 100 will transition to an initial ready status wherein the tires have been adjusted to the air pressure as defined in the selected mode. In step 527, the central tire inflation system 100 will display the current tire pressure on the graphical display 152. Step 529, the central tire inflation system 100 will continuously monitor the tire air pressure on which the central tire inflation system 100 is installed. In step 531, the valve 95 having the integrated pressure sensor detects a pressure in a tire that has deviated from the tire air pressure parameter in the active mode. Step 533, the central processing unit 90 transmits a signal to the control panel 150 to display a warning signal on the graphical display that a tire has an air pressure that has deviated from the stored parameters for the active mode. In step 535, the central processing unit 90 transmits a signal to the valve 95 to initiate either inflation or deflation of the tires so as to return the tire air pressure to the tire pressure parameter of the active mode. Step 537, the central processing unit 90 records the deviation and stores in the memory thereof particularly in a fault log database for future access by a user. In step 539, the central tire inflation system 100 continues to monitor the tire air pressure of the vehicle and further monitors the speed of the vehicle. It is contemplated within the scope of the present invention that the central tire inflation system 100 could be operably integrated into the speedometer of the vehicle so as to extract the vehicle speed and display on the graphical display 152 of the control panel 150. Those skilled in the art should recognize that the vehicle speed could be obtained utilizing alternate devices and/or techniques. In step 541, the central tire inflation system 100 continues to monitor the tire pressure and compare to the tire pressure parameters of the active mode. Step 543, the central tire inflation system 100 will display a warning if the vehicle speed exceeds the recommended speed for the active mode. The warning signal is generated by the central processing unit 90 and is transmitted to the control panel 150 for display to the user. In step 545, the user completes the vehicle use. In step 547, a second user will select a mode in which the user will begin to utilize the vehicle to which the central tire inflation system 100 is mounted. The aforementioned second user could be the same individual initiating reuse of the vehicle. Operation of the central tire inflation system 100 returns to step 513 and resume all of the aforementioned steps of operation through step 513 to step 545.

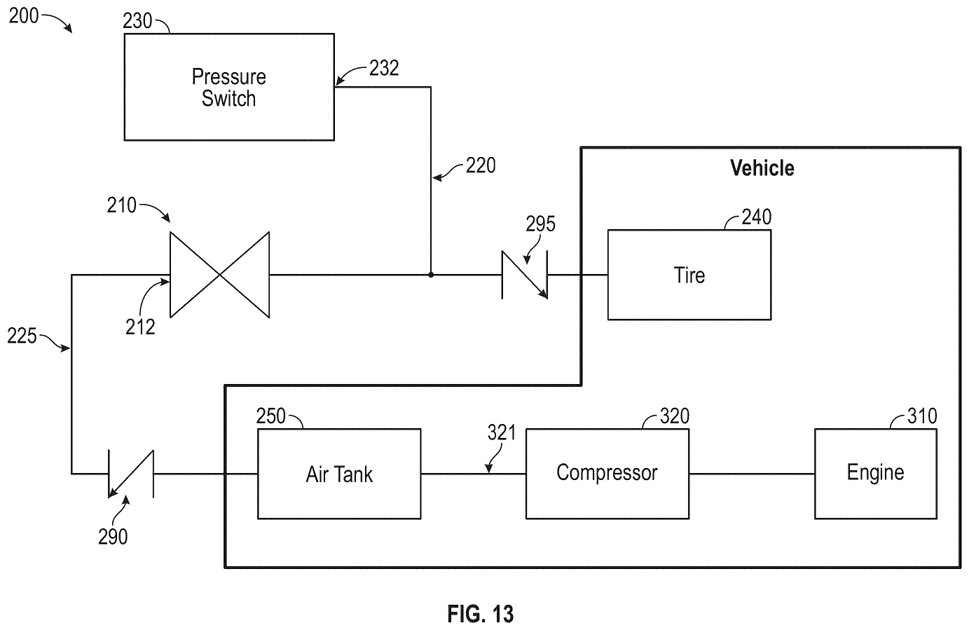

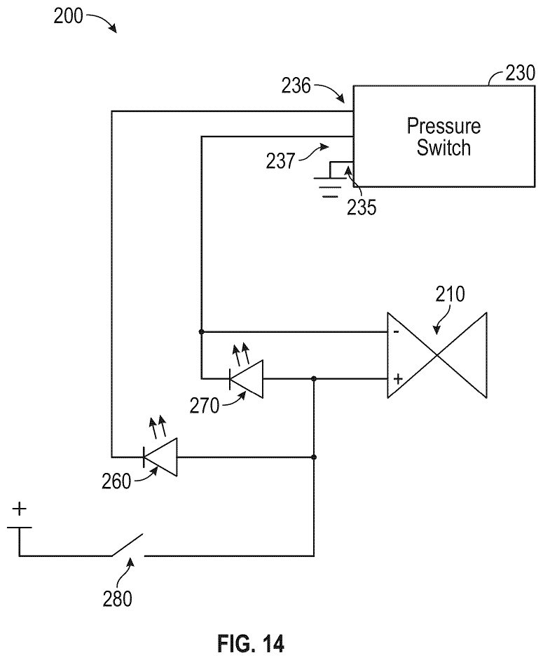

Another embodiment of the present invention, which may be illustrated in FIGS. 13 and 14 may not include a controller 80. Such an embodiment may be a system for inflating vehicle tires 200 and no provisions for deflating the tires 240 through the system 200 may be made. Such a system 200 may include a pressure switch 230 and a valve 210. The pressure switch 230 may have an input port 232 that is in fluid communication with a pneumatic pathway 220. When the pressure of the pneumatic pathway 220 measured by the pressure switch 230 at the input port 232 drops below a threshold value, the pressure switch 230 may actuate the valve 210 to an opened position. When the pressure of the pneumatic pathway 220 is above the threshold value, the valve 210 may not be actuated and may remain in a closed position.

The threshold value may be adjustable. In one embodiment, the threshold value may be adjustable at the time of manufacturing the system 200. In another embodiment, the threshold value may remain adjustable throughout the life of the system 200. The threshold vale may range from 25 to 105 psi. In one embodiment, the threshold value may be between 80 and 100 psi. In one embodiment, the threshold value may be set at 105, 100, 95, or 90 psi.

The pneumatic pathway 220 may be in fluid communication with the input port 232 of the pressure switch 230 and the outlet of the valve 211. The pneumatic pathway 220 may also be in fluid communication with one or more vehicle tires 240. In one embodiment, a one-way check valve 295 may be located in the pneumatic pathway 220 between the outlet 211 of the valve and the vehicle tire 240. The one-way check valve 25 may prevent air from leaving the tire 240 to enter the pneumatic pathway 220. The one-way check valve 295 may have a cracking pressure between 110 and 70 psi. In one embodiment, the one-way check valve 295 may have a cracking pressure between 100 and 80 psi. In one embodiment, the one-way check valve 295 may have a cracking pressure of 90 psi.

The valve 210 may have an inlet 212 in fluid communication with an air tank 250. In one embodiment, a one-way check valve 290 may be positioned in a pneumatic pathway 225 between the valve inlet 212 and the air tank 250. In such an embodiment, the one-way check valve 290 may prevent air from flowing into the air tank 250. The air in the air tank 250 may have a pressure greater than the threshold value of the system 200. The one-way check valve 290 may have a cracking pressure between 110 and 70 psi. In one embodiment, the one-way check valve 290 may have a cracking pressure between 100 and 80 psi. In one embodiment, the one-way check valve 290 may have a cracking pressure of 90 psi.

In addition to the pneumatic configuration of the system 200 depicted in FIG. 13, there may be electrical connections between the pressure switch 230 and the valve 210 as depicted at least in FIG. 14. A positive terminal of the valve 210 may be connected to an external power source. A switch 280 may be placed in line with the positive terminal of the valve 210 and the external power source. In the open position, the switch 280 may power down the system 200 while the system may be energized when the switch 280 is in the closed positioned.

The pressure switch 230 may have three electrical terminals. A first electrical terminal 235 of the pressure switch 230 may be in electrical connection with a ground of the vehicle on which the tire 240 is mounted. A second electrical terminal 236 of the pressure switch 230 may be in electrical connection with the positive terminal of the valve 210. An LED 260 may be positioned between the switch 280 and the second electrical terminal of the pressure switch 230. In one embodiment, this LED 260 may emit a green light. When the LED 260 is illuminated, this may provide a visual indication that the system 200 is receiving power and the switch 280 is in the on position.

A third electrical terminal 237 of the pressure switch 230 may be in electrical communication with a negative terminal of the valve 210. When the pressure switch 230 is activated, because the pressure value in the pneumatic pathway 220 drops below a threshold level, the pressure switch 230 may be activated, in turn activating the valve 210 to the opened position. A second LED 270, which may be red, may be positioned in line with the third electrical terminal 237 of the pressure switch 230 and the external power supply. In such an embodiment, the second LED 270 may illuminate when the pressure switch 230 is actuated.

The system 200 may also include an engine 310 and an air compressor 320 that are carried by the same vehicle that carries the tire 240. In such an embodiment, the vehicle engine 310 may provide power to the air compressor 320 and the air compressor 320 may have an outlet 321 in fluid communication with the air tank 250. In such a configuration, pressurized air output by the air compressor 320 may be stored in the air tank 250.

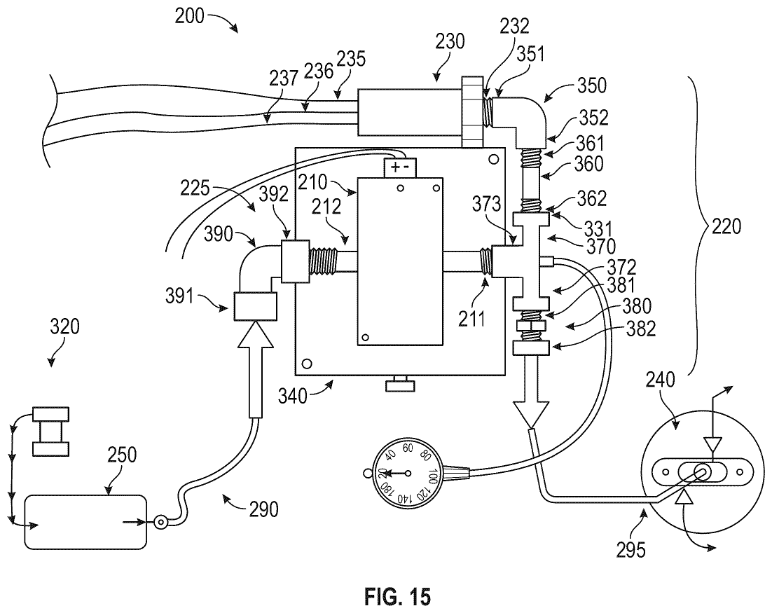

In one embodiment, as depicted in FIG. 15, it may be desirable for the valve 210 and the pressure switch 230 to be carried by a housing 340. In such an embodiment, the pneumatic passageway 220 in fluid communication with the input port 232 of the pressure switch may include a 90 degree bend proximate to the pressure switch 230. The physical structure that comprises the pneumatic passageway 220 may include a ¼″ female to female fitting with a 90 degree bend 350. One end 351 of the female to female fitting may be secured to the pressure switch 230 and the opposing end 352 of the female to female fitting 350 may be secured to a first end 361 of a 1½″ long ¼″ nipple 360. The other end 362 of the nipple 360 may secure to a first side 371 of a ¼″ branch tee 370, with the outlet 372 of the branch tee 370 directly opposing the portion secured to the nipple 360 secured to a tube 380 with a ¼″ npt fitting on a first end 381 and a ⅜″ fitting on the opposing end 382. The ⅜″ fitting may be secured to the tire 240. The third outlet 373 of the branch tee 370 may be in fluid communication with the outlet 211 of the valve 210.

A pneumatic pathway 225 in fluid communication with an inlet 212 to the valve 210 may have a 90 degree bend proximate the valve 210. The physical structure that comprises the pneumatic pathway 225 may include a 90 degree fitting 390. A first end 391 of the 90-degree fitting 390 may be ⅜″ and adapted to be placed in fluid communication with the outlet 321 of the air compressor 320. This second end 392 of the 90-degree fitting 390 may include a ¼″ fitting adapted to be placed in fluid communication with an inlet 312 to the valve 310.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A system for inflating vehicle tires comprising:
a valve positionable between an opened and a closed position;
a pneumatic pathway having a pressure value and in fluid communication with an outlet of the valve and an input of a pressure switch;
a vehicle tire in fluid communication with the pneumatic pathway; and
the pressure switch configured to actuate the valve to the opened position when the pressure value of the pneumatic pathway drops below a threshold value; and
wherein an inlet of the valve is configured to be in fluid communication with an air tank having a pressure value.

2. The system of claim 1 wherein the pressure value of the air tank is configured to be greater than the threshold value.

3. The system of claim 1 wherein the threshold value is selectable between 25 and 105 psi.

4. The system of claim 1 wherein the threshold value is selectable between 80 and 100 psi.

5. The system of claim 1 further comprising:
a power switch; and
a first led configured to actuate when the power switch is in a closed configuration.

6. The system of claim 1 further comprising a second led configured to actuate when the pressure switch is activated.

7. The system of claim 1 further comprising the air tank in fluid communication with the inlet of the valve.

8. The system of claim 7 further comprising:
an engine; and
an air compressor configured to receive power from the engine and having an outlet in fluid communication with the air tank.

9. The system of claim 1 further comprising a first one-way check valve positioned between an outlet of the air tank and the inlet of the valve; and
wherein the first one-way check valve prevents the flow of air from the inlet of the valve into the air tank.

10. The system of claim 1 further comprising an air passageway having a ninety-degree bend positioned between the air tank and the inlet of the valve.

11. The system of claim 1 further comprising a second one-way check valve positioned between an outlet of the valve and the tire; and
wherein the second one-way check valve prevents the flow of air from the tire into the pneumatic pathway.

12. A system for inflating vehicle tires comprising:
a valve positionable between an opened and a closed position;
a pneumatic pathway having a pressure value and in fluid communication with an outlet of the valve and an input of a pressure switch;
a vehicle tire in fluid communication with the pneumatic pathway;
the pressure switch configured to actuate the valve to the opened position when the pressure value of the pneumatic pathway drops below a threshold value;
an air tank having a pressure value greater than the threshold value and in fluid communication the an inlet of the valve;
a power switch; and
a first led configured to actuate when the power switch is in a closed configuration.

13. The system of claim 12 wherein the threshold value is selectable between 25 and 105 psi.

14. The system of claim 12 wherein the threshold value is selectable between 80 and 100 psi.

15. The system of claim 12 further comprising a second led configured to actuate when the pressure switch is activated.

16. The system of claim 15 further comprising:
an engine; and
an air compressor configured to receive power from the engine and having an outlet in fluid communication with the air tank.

17. The system of claim 12 further comprising a first one-way check valve positioned between an outlet of the air tank and the inlet of the valve; and
wherein the first one-way check valve prevents the flow of air from the inlet of the valve into the air tank.

18. The system of claim 12 further comprising an air passageway having a ninety-degree bend positioned between the air tank and the inlet of the valve.

19. The system of claim 12 further comprising a second one-way check valve positioned between an outlet of the valve and the tire; and
wherein the second one-way check valve prevents the flow of air from the tire into the pneumatic pathway.

20. A system for inflating vehicle tires comprising:
a valve positionable between an opened and a closed position;
a pneumatic pathway having a pressure value and in fluid communication with an outlet of the valve and an input of a pressure switch;
a vehicle tire in fluid communication with the pneumatic pathway;
the pressure switch configured to actuate the valve to the opened position when the pressure value of the pneumatic pathway drops below a threshold value;
an air tank having a pressure value greater than the threshold value and in fluid communication the an inlet of the valve;
a power switch;
a first led configured to actuate when the power switch is in a closed configuration;
a second led configured to actuate when the pressure switch is activated;
an engine;
an air compressor configured to receive power from the engine and having an outlet in fluid communication with the air tank;
a first one-way check valve positioned between an outlet of the air tank and the inlet of the valve;
a second one-way check valve positioned between an outlet of the valve and the tire; and
an air passageway having a ninety-degree bend positioned between the air tank and the inlet of the valve; and
wherein the threshold value is selectable between 80 and 100 psi;
wherein the first one-way check valve prevents the flow of air from the inlet of the valve into the air tank; and
wherein the second one-way check valve prevents the flow of air from the tire into the pneumatic pathway.
